(19) United States
(12) Patent Application Publication
(10) Pub. No.: US 2025/0259176 A1
(43) Pub. Date: Aug. 14, 2025

(54) SYSTEMS AND METHODS FOR GENERATING VARIABLE SELF-EXECUTING PROGRAMS LINKED TO DESIGNATED OFF-CHAIN COMPUTER RESOURCES FOR USE IN SECURE ENCRYPTED COMMUNICATIONS ACROSS DISPARATE COMPUTER NETWORKS

(71) Applicant: Capital One Services, LLC, McLean, VA (US)

(72) Inventors: Lawrence DOUGLAS, McLean, VA (US); Kevin KEENAN, McLean, VA (US)

(73) Assignee: Capital One Services, LLC, McLean, VA (US)

(21) Appl. No.: 18/442,050

(22) Filed: Feb. 14, 2024

(51) Int. Cl. G06Q 20/40; G06Q 20/38

(52) U.S. Cl. CPC G06Q 20/4014; G06Q 20/3827; G06Q 20/3829; G06Q 20/389; G06Q 20/405

(57) ABSTRACT

Systems and methods related to a variable self-executing program. A variable self-executing program comprises a self-executing program that is minted with an indication of a non-transferable ownership wallet (e.g., a digital wallet for which the self-executing program is minted), a non-transferable network address that has permissions for updating metadata for the variable self-executing program, and an off-chain profile state based on a specific user corresponding to the digital wallet.

### BACKGROUND

In recent years, the use of blockchain technology for various applications, including, but not limited to, smart contracts, cryptocurrency, smart finance, blockchain-based data storage, etc. (referred to collectively herein as blockchain applications), has exponentially increased. Each of these applications benefits from blockchain technology that allows for the recording of information that is difficult or impossible to change (either in an authorized or unauthorized manner). For example, a blockchain is essentially a digital ledger of transactions that is duplicated and distributed across the entire network of computer systems on the blockchain. That is, the digital ledger of a blockchain is a decentralized source of information that does not require a central authority to monitor transactions, maintain records, and/or enforce rules. Instead, technology underlying the blockchain network, namely cryptography techniques (e.g., secret key, public key, and/or hash functions), consensus mechanisms (e.g., Proof of Work (POW), Proof of Stake (POS), Delegated Proof of Stake (dPOS), Practical Byzantine Fault Tolerance (pBFT), Proof of Elapsed Time Broadly (PoET), etc.), and computer networks (e.g., peer-to-peer (P2P), the Internet, etc.), combine to provide a decentralized environment that enables the technical benefits of blockchain technology.

However, despite these benefits and despite the wide-ranging number of potential applications, practical implementations of blockchain technology have been hindered by several technical problems. First, blockchain technology, despite its decentralized nature, faces scalability issues and/or low transaction speeds when attempting to accommodate many users at a given time. Second, depending on the application and the intent of the users, the key benefits of blockchain technology, such as a public ledger, use of digital wallets, and/or immutable transactions, may be seen negatively by users who wish to maintain privacy of transactions, wish to know the true identities of users involved in transactions, and/or wish to reverse unauthorized transactions, respectively.

### SUMMARY

Systems and methods are described herein for novel uses and/or improvements to blockchain technology. In particular, the systems and methods relate to the creation, use, and integration, with legacy systems, of a variable self-executing program. For example, the variable self-executing program shares characteristics with conventional self-executing programs (e.g., smart contracts) but also divergences from conventional self-executing programs in that it may more easily and efficiently interact with legacy (e.g., non-blockchain) systems.

For example, a fundamental concept of self-executing programs is that, once published on the blockchain, the underlying logic of the self-executing program does not change. This fundamental concept provides the innate security and authenticity for the self-executing program. However, this fundamental concept also creates a technical problem in that underlying logic cannot be updated during the life of the self-executing program, which may lead to the self-executing program becoming obsolete (e.g., the program may direct a user to a data source or website that no longer exists, the program may require inputs in a standard or protocol that is no longer used, etc.).

One solution to overcoming this problem is to create new self-executing programs with the preferred properties (e.g., updated directories, updated networking protocols, etc.) as the need arises. However, simply creating new self-executing programs each time new properties and/or metadata are needed limits the ability of the self-executing program to be linked to off-chain resources (e.g., a physical product, a user profile, a payment instrument, and/or other object with a lifetime that may outlive a conventional protocol update schedule). Due to this flaw, blockchain applications linked to off-chain resources have conventionally been limited to non-fungible tokens (NFTs) that provide basic authentication details (e.g., details that do not require updates).

In contrast to the aforementioned solution, the systems and methods describe the use of a novel mechanism for a novel self-executing program that does not have static properties and/or metadata (e.g., a variable self-executing program). Instead, the self-executing program allows for a specific property of the self-executing program to be updated through the use of one or more on-chain rule configurations. By doing so, the system enables the variable self-executing program to be reusable for multiple blockchain functions, represent dynamically changing data, and/or be linked to off-chain resources.

As such, the variable self-executing program mitigates a fundamental limitation of blockchain technology—its limited ability to interact with data and systems existing outside their native blockchain environment (e.g., off-chain data). However, the use of such a novel mechanism creates an additional technical hurdle. Notably, the innate security and immutability of the self-executing program has been lost. To overcome this, the variable self-executing program comprises on-chain rule configurations that are designed to generate automatic response to receiving encoded instructions. The encoded instructions are further based on a current on-chain configuration of the self-executing program in which the specific on-chain configuration is based on the state of the off-chain resource to which the self-executing program is linked and to which only a provider of the off-chain resource has access. As such, in response to a request to access, modify, and/or otherwise perform a blockchain function, the system determines, based on the off-chain user resource, a current on-chain rule configuration of the self-executing program. The system may then execute an encoded instruction based on the first on-chain rule configuration to fulfill the request.

In this aspect, systems and methods are described for modifying automated responses of self-executing programs stored on network blocks containing cryptographic hashes of previous blocks, wherein the self-executing programs comprise variable metadata properties linked to designated off-chain resources for use in secure encrypted communications across disparate computer networks. For example, the system may receive, from a user-specific digital storage resource application on a user device, a user request to update a self-executing program with variable metadata properties. The system may retrieve, in response to the user request, an off-chain user profile corresponding to the user-specific digital storage resource application. The system may determine, based on the off-chain user profile, a first on-chain rule configuration of the self-executing program. The system may execute a first encoded instruction based on the first on-chain rule configuration for the self-executing program, wherein the first encoded instruction causes a first automatic response to a first type of blockchain function of a plurality of types of blockchain functions based on the first on-chain rule configuration, wherein the first automatic response comprises an update to the first on-chain rule configuration. The system may cause to be generated, based on the first encoded instruction, a second on-chain rule configuration for the self-executing program.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative diagram for blockchain functions related to a variable self-executing program, in accordance with one or more embodiments.

FIG. 2 shows an illustrative diagram for a blockchain network in which a variable self-executing program may be used, in accordance with one or more embodiments.

FIG. 3 shows illustrative components for a system used in facilitating blockchain functions related to a variable self-executing program, in accordance with one or more embodiments.

FIG. 4 shows an illustrative user interface for a menu for a user-specific digital storage resource application, in accordance with one or more embodiments.

FIG. 5 shows a flowchart of the steps involved in modifying automated responses of self-executing programs, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

Systems and methods describe the use of a novel mechanism for a novel self-executing program that does not have static properties and/or metadata (e.g., a variable self-executing program). Instead, the self-executing program allows for a specific property of the self-executing program to be updated through the use of one or more on-chain rule configurations. By doing so, the system enables the variable self-executing program to be reusable for multiple blockchain functions, represent dynamically changing data, and/or be linked to off-chain resources.

For example, the variable self-executing program may comprise properties that represent a balance, terms, and account characteristics similar to that of credit card. That is, as opposed to a self-executing program that is linked to a specific item (e.g., located at an Internet address), the self-executing program may represent variable data (e.g., data that is updated by a third-party entity) such as current terms of a payment instrument. For example, the variable metadata properties may be determined based on on-chain rule configurations selected by an off-chain resource, wherein the updates to the on-chain rule configurations are provided via an oracle controlled by the off-chain resource. For example, the variable self-executing program may represent a balance of credit, terms for credit, etc., that are updated by a third party (e.g., a credit provider). The third party may both perform updates to the balance and control the data source of the updates (e.g., an oracle).

As such, the variable self-executing program mitigates a fundamental limitation of blockchain technology: its limited ability to interact with data and systems existing outside their native blockchain environment (e.g., off-chain data). However, the use of such a novel mechanism creates an additional technical hurdle. Notably, the innate security and immutability of the self-executing program has been lost. To overcome this, the variable self-executing program comprises on-chain rule configurations that are designed to generate an automatic response to receiving encoded instructions. The encoded instructions are further based on a current on-chain configuration of the self-executing program in which the specific on-chain configuration is based on the state of the off-chain resource to which the self-executing program is linked and to which only a provider of the off-chain resource has access. As such, in response to a request to access, modify, and/or otherwise perform a blockchain function, the system determines, based on the off-chain user resource, a current on-chain rule configuration of the self-executing program. The system may then execute an encoded instruction based on the first on-chain rule configuration to fulfill the request.

The on-chain configurations may cause different automated responses to different requests and/or triggers. For example, on-chain configurations may comprise business logic that can act as a trigger. In some embodiments, the on-chain configurations may comprise merchant-specific rules (e.g., a specific merchant) that allow retailers to strike deals with individual card issuers and promote their store while the rules are in place and/or store-specific rules (e.g., a specific merchant location) to allow more targeted offers.

In some embodiments, the on-chain configurations may comprise location-specific rules (e.g., location on device must be turned on, card must be used with phone for card present transactions), which may serve as fraud protection. Additionally or alternatively, on-chain configurations may comprise online transactions (e.g., only virtual cards may be used online for the account/subaccount/at specific merchant types or specific merchants), which may also serve as fraud protection. For example, the on-chain configuration may comprise rules for a user to receive benefits/actions by committing to drive all their spend on an issuer's card. With every transaction or periodically, the issuer may make a call to a financial aggregation service to retrieve the transactions from all other financial relationships of the customer to confirm they are not spending on other cards.

Additionally or alternatively, the on-chain configurations may cause different automated responses that may comprise one or more actions. For example, actions based on a trigger may include fees based on a trigger (e.g., phone call to a human agent), savings based on a trigger (e.g., setup of automated payment, paperless notifications, a duration without contact to a human agent, use of security features like two-factor authentication, authentication application, virtual card number control features, opting into location sharing in the mobile application so that card transactions and phone location can be correlated), benefits based on a trigger (e.g., increase in rewards, fee reversal, modification/reduction of interest rates for a particular purchase/subaccount/account), penalties based on a trigger (e.g., fee-based limit, rewards reduction/spend, etc.), card behavior based on a trigger (e.g., turn off card, turn off cash withdrawal, reduce card limit), etc.

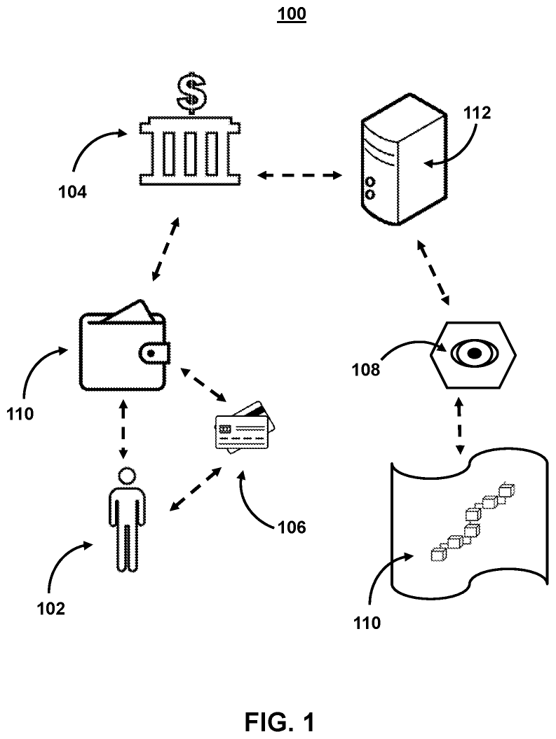

FIG. 1 shows an illustrative diagram for blockchain functions related to a variable self-executing program, in accordance with one or more embodiments. For example, FIG. 1 includes ecosystem 100. Ecosystem 100 includes user 102. User 102 may comprise a human user or other entity. In some embodiments, user 102 may correspond to a user account. For example, user 102 may correspond to a user account for a user-specific digital storage resource application on a user device.

Ecosystem 100 also includes lender 104, which may comprise a credit card provider, a line of credit provider, or a bank and/or a service provider. In some embodiments, lender 104 may comprise a payment service network. For example, an acquiring bank may receive payment authorization requests from a source and send them to an issuing bank (which may include, or be a separate entity from, the acquiring bank). The acquiring bank may then relay a response from the issuing bank to the source. In some embodiments, the acquiring bank may be a third-party entity. The acquiring bank may provide a service or device that allows a source to accept credit cards as well as send credit card payment details to a network. Upon receipt, the network may forward the payment authorization to the acquiring bank.

The network may include entities that operate credit card networks that process credit card payments worldwide, extend lines of credit, and/or govern interchange fees. For example, an issuing bank may be a financial institution that issues a credit card and/or line of credit linked to a variable self-executing program involved in a blockchain function (e.g., a transaction). An issuing bank may receive a payment authorization request from the credit card network and either approve or decline the transaction.

Ecosystem 100 also includes a receiver, which may be associated with a store and/or vendor that sells goods and/or services to user 102 and/or facilitates a blockchain function (e.g., a transaction). The receiver (e.g., receiver 106), which may be a merchant, may accept credit card payments, debits against a line of credit, etc. Receiver 106 may also send credit, debit instructions, and/or user account information to, and request payment authorization from, an issuing bank corresponding to the self-executing program (or a line of credit related to the self-executing program). Receiver 106 may be assigned information by a network upon registration. That information may include a merchant/source identifier, a network name, and an address. The network may further generate a cleansed network name based on a native network name (e.g., a network name based on a proprietary and/or non-public algorithm for generating a network name based on available data of a merchant when the merchant registers with the network).

During a blockchain function in ecosystem 100, user 102 may use a variable self-executing program. As described herein, the variable self-executing program may serve as a mechanism for performing blockchain-based payments (e.g., a payment between user 102 and receiver 106). For example, when making blockchain-based payments today, users are limited to two types of funding sources: (1) their cryptocurrency holdings or (2) borrowed cryptocurrency (e.g., via collateralized loans). The use of a variable self-executing program introduces a mechanism for providing a new funding mechanism (and payment instrument) for transactions that occur on rule set based on the first on-chain rule configuration platforms such as lines of credit.

As described herein, a variable self-executing program is a self-executing program that includes variable metadata. For example, the self-executing program may have a rule set based on the first on-chain rule configuration that is capable of adapting and changing metadata for the self-executing program in response to external events and data. For example, a self-executing program may be differentiated from another through a 1-of-1 tokenID and its unique contract address. From there, metadata such as images, video files, and/or other data may be stored. However, in conventional self-executing programs, the metadata attached to them is fixed upon the self-executing program being minted on a blockchain. In contrast, a variable self-executing program allows for changes in the metadata to be triggered by a rule set based on the first on-chain rule configuration. For example, the system may encode automatic changes within the self-executing program's rule set based on the first on-chain rule configuration, which provides instructions to the underlying self-executing program regarding when and how its metadata should change.

To provide the aforementioned functionality, the variable self-executing program may comprise one or more properties such as metadata that can be modified (possibly multiple times per day), metadata that can only be modified by permissioned account/network addresses, tokens that are specific to an account on a blockchain and linked to an identity, and/or token holders (e.g., user 102) who cannot transfer the token to any address. The tokens can be used as a form of payment (means of exchange) and are interoperable with other rule set based on the first on-chain rule configurations. Payments using the token may create a liability on the borrower (e.g., user 102). Additionally, token metadata may be stored off-chain, and the system may use oracles (e.g., oracle 108) to represent the data on-chain and/or receive external data for adapting and changing metadata for the self-executing program.

User 102, lender 104, and/or receiver 106 may interact via one or more user-specific digital storage resource applications (e.g., digital wallets). For example, the digital wallet may comprise a repository that allows users to store, manage, and trade their cryptocurrencies and assets, interact with blockchains, and/or conduct blockchain functions using one or more applications. The digital wallet may be specific to a given blockchain protocol or may provide access to multiple blockchain protocols. In some embodiments, the system may use various types of wallets such as hot wallets and cold wallets. Hot wallets are connected to the Internet while cold wallets are not. Most digital wallet holders hold both a hot wallet and a cold wallet. Hot wallets are most often used to perform blockchain functions, while a cold wallet is generally used for managing a user account and may have no connection to the Internet.

Ecosystem 100 may include user-specific digital storage resource applications. For example, user-specific digital storage resource application 110 may comprise a digital wallet for user 102. User-specific digital storage resource application 110 may comprise a second on-chain rule configuration for a variable self-executing program (e.g., a variable self-executing program corresponding to a rule set based on the first on-chain rule configuration (e.g., on-chain rule configuration 110)). In some embodiments, user-specific digital storage resource application 110 may comprise a mobile application or other user interface for a user (e.g., user 102).

Ecosystem 100 includes user-specific digital storage resource application 110, which may comprise a multi-signature digital wallet application. The multi-signature digital wallet application may use a multi-party computation (MPC) system. MPC involves the use of multiple parties, each of which holds respective private data that may be used to evaluate a computation without ever revealing any of the private data held by each party. For example, each party of the multiple parties may possess private data (e.g., d₁, d₂, . . . , d_{N}). Together, the parties may use their respective private data to compute a value of a public function (e.g., F(d₁, d₂, . . . , d_{N})). While the private data is used to compute a value based on the function, the private data is kept private during that process.

The use of an MPC-based key lessens the risk involved with the loss of a second on-chain rule configuration and/or the second on-chain rule configuration being accessed by unauthorized parties. For example, conventional key-share systems rely on a public-second on-chain rule configuration where the security of the system is tied to the second on-chain rule configuration remaining private. In some cases, these keys are stored in various user-specific digital storage resource applications (or digital wallets).

Ecosystem 100 includes user-specific digital storage resource application 110, which may comprise a digital wallet application for lender 104. Ecosystem 100 includes user-specific digital storage resource application 110, which may comprise a digital wallet application for receiver 106. User-specific digital storage resource application 110 may be used to interact with rule set based on first on-chain rule configuration 114. Rule set based on first on-chain rule configuration 110 in some embodiments may comprise a plurality of rule set based on the first on-chain rule configurations. Rule set based on first on-chain rule configuration 114 may be used to provide a plurality of functions such as underwriting transactions (or extending lines of credit), minting variable self-executing programs, managing self-executing programs, authorizing transactions, providing settlement actions, and/or performing bill payment functions.

Rule set based on the first on-chain rule configuration may allow issuers to settle using cash off-chain. For example, issuers may trigger an interbank transfer upon receiving the settlement request in rule set based on the first on-chain rule configuration. User-specific digital storage resource applications 110 may then send or receive payments/transfers between transacting parties (e.g., borrowers, lenders, and receivers).

For example, an issuer wallet (e.g., user-specific digital storage resource application 110) for settling payments with receivers (e.g., receiver 106) and enables issuers to send crypto assets (e.g., USDC, Bitcoin, private fungible tokens) to receivers (e.g., user-specific digital storage resource applications 110). In some embodiments, user-specific digital storage resource application 110 may enable direct funding by the issuer or via an omnibus account. For example, ecosystem 100 may provide a mechanism for issuers to settle using private tokens (e.g., fungible ERC-20 token) rather than USDC or Bitcoin. Rule set based on the first on-chain rule configuration may have a rule set based on the first on-chain rule configuration function for merchants to redeem private tokens for fiat (e.g., USD), cryptocurrency (e.g., Bitcoin), or stablecoins (e.g., USDC). The system may use a multisig wallet (e.g., user-specific digital storage resource application 110) to manage Bill Pay on the borrower's (e.g., user 102) account.

For example, rule set based on the first on-chain rule configuration and/or code deployed on a decentralized computer platform like Ethereum may be used for underwriting credit applications. In such cases, user 102 may submit personal information into the rule set based on the first on-chain rule configuration. Rule set based on the first on-chain rule configuration may use an oracle (e.g., oracle 108) to utilize other off-chain creditworthiness data for underwriting a credit application (e.g., to generate outputs of the underwriting process that would be an approval decision, credit line amount, interest rate, rewards, etc.). In some embodiments, the underwriting process may be done off-chain, and the system may use oracles (e.g., oracle 108) to represent underwriting results and outputs on-chain.

Oracles 108 may receive data streams comprising off-chain information. As referred to herein, “a data stream” may refer to data that is received from a data source that is indexed or archived by time. This may include streaming data (e.g., as found in streaming media files) or may refer to data that is received from one or more sources over time (e.g., either continuously or in a sporadic nature). A data stream segment may refer to a state or instance of the data stream. For example, a state or instance may refer to a current set of data corresponding to a given time increment or index value. For example, the system may receive time series data as a data stream. A given increment (or instance) of the time series data may correspond to a data stream segment. Rule set based on the first on-chain rule configuration may receive each instance of data (e.g., as passed through and/or filtered by oracle 108) in order to determine whether or not a blockchain function and/or dynamic update to metadata for the variable self-executing program is triggered.

In some embodiments, the system may receive off-chain characteristics via the data stream. As referred to herein, an “off-chain characteristic” includes any data that is stored off-chain. In contrast, an “on-chain characteristic” includes any data or characteristic that is stored on-chain. An off-chain characteristic may comprise an on-chain rule configuration such as a balance of a line of credit, an account the token is linked to, a maximum credit line, a current balance, an interest rate, etc.

In some embodiments, oracle 108 may receive data streams from an off-chain resource (e.g., resource 112). Resource 112 may comprise a dedicated and/or centralized resource that is controlled and/or operated by lender 104. For example, resource 112 may comprise storage locations that both transmit data streams and store metadata referenced by rule set based on the first on-chain rule configuration. As the metadata itself is stored at a centralized location (e.g., as identified by rule set based on the first on-chain rule configuration), it may be updated by the non-transferable network address in a secured manner. That is, the metadata is stored off-chain and at a secure location, which allows for high transaction and update speeds for high volumes of data received from the centralized location, while the non-transferable attributes of the self-executing program ensure that only a user for which the self-executing program was minted may access the centralized location.

Oracles 108 may comprise various architecture. For example, oracle 108 may constitute an input oracle, an output oracle, cross-chain oracles, and/or computing oracles. An input oracle fetches data from the real world (e.g., off-chain) and delivers it onto a blockchain network for rule set based on the first on-chain rule configuration consumption. Output oracles allow rule set based on the first on-chain rule configurations to send commands to off-chain systems that trigger them to execute certain actions (e.g., informing a banking network to make a payment, adjusting metadata, and/or transmitting a confirmation of payment to a point-of-sale device (e.g., for receiver 106)). Cross-chain oracles enable interoperability for moving both data and assets between blockchains, such as using data on one blockchain to trigger an action on another or bridging assets cross-chain so they can be used outside the native blockchain they were issued on. Computing oracles use secure off-chain computation to provide decentralized services that are impractical to do on-chain due to technical, legal, and/or financial constraints. For example, ecosystem 100 may use a computing oracle to perform verifications and validations of data received from resource 112. For example, the various oracles may allow for data to be communicable between the self-executing program based on the first on-chain rule configuration and the off-chain resource using a blockchain oracle.

In some embodiments, resource 112 may store metadata for rule set based on the first on-chain rule configuration. In conventional systems, self-executing programs may point to either an InterPlanetary File System (IPFS) hash or an HTTP URL on the web. The variable self-executing program may specify a standard JavaScript Object Notation (JSON) format for encoding metadata. Rule set based on the first on-chain rule configuration may then store as a Universal Resource Identifier (URI) because storing a JSON would be both costly and resource-intensive. However, the URI string leads to a site (e.g., resource 112) where the token's JSON description can be found.

For example, in some embodiments, the system may generate encoded instructions for the self-executing program using a JSON format. The system may then store, at an off-chain resource, the encoded instructions. The system may then determine a location of the off-chain resource (e.g., resource 112), wherein the off-chain resource comprises a centralized data storage source for storing the first on-chain rule configuration. The system may then generate a URI for the off-chain resource and encode the URI in the self-executing program.

The self-executing program may comprise one or more “metadata properties.” As referred to herein, an on-chain rule configuration may comprise a current state or instance. The on-chain rule configuration may reflect a dynamic property of the self-executing program such as a balance of a line of credit, an account the token is linked to, a maximum credit line, a current balance, an interest rate, a term, an expiration/initiation, etc. The self-executing program may also include static metadata properties such as a user, account, and/or digital wallet to which the token is linked. For example, once minted, the token would be transferred to the borrowing user's cryptographic public key/address (e.g., digital wallet), after which the token may be non-transferable as indicated by the static on-chain rule configuration.

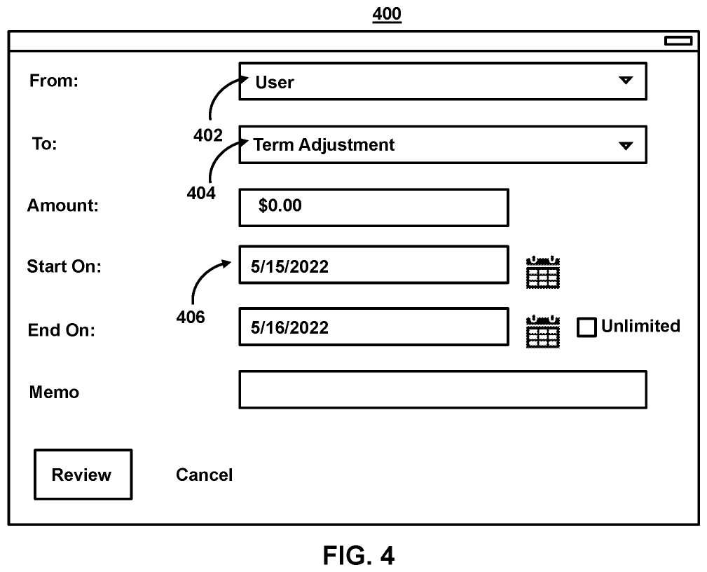

After creation, blockchain functions may be conducted by rule set based on the first on-chain rule configuration for authorizing transaction requests and settling payments between the issuer (e.g., lender 104) and the receiver (e.g., receiver 106). Receivers'/sellers' payment requests can be made into the rule set based on the first on-chain rule configuration with the borrower's (e.g., user 102) public key. User authorizations (e.g., from user 102) would be made using their second on-chain rule configurations. For example, users (e.g., user 102) may receive authorization request notifications (e.g., via user interface 400 (FIG. 4)) that user 102 would approve using a second on-chain rule configuration.

Issuers' authorization decisions would be made through a rule set based on the first on-chain rule configuration function that would approve or decline based on their credit, fraud, etc., policies. Oracles 108 may enforce these policies and/or may use on-chain rule set based on the first on-chain rule configurations for performing anti-money laundering and/or know-your-customer checks on the receiver/seller. Rule set based on the first on-chain rule configuration may also include the capability to set a time period to reclaim payments (for chargebacks or re-bills due to disputes/fraud). For example, the system may determine an encoded instruction for the rule set based on the first on-chain rule configuration, wherein the encoded instruction causes a time period for use of or a specific use of the self-executing program. Approved authorizations would trigger the transfer of funds from the issuer's wallet to the receiver's/seller's wallet.

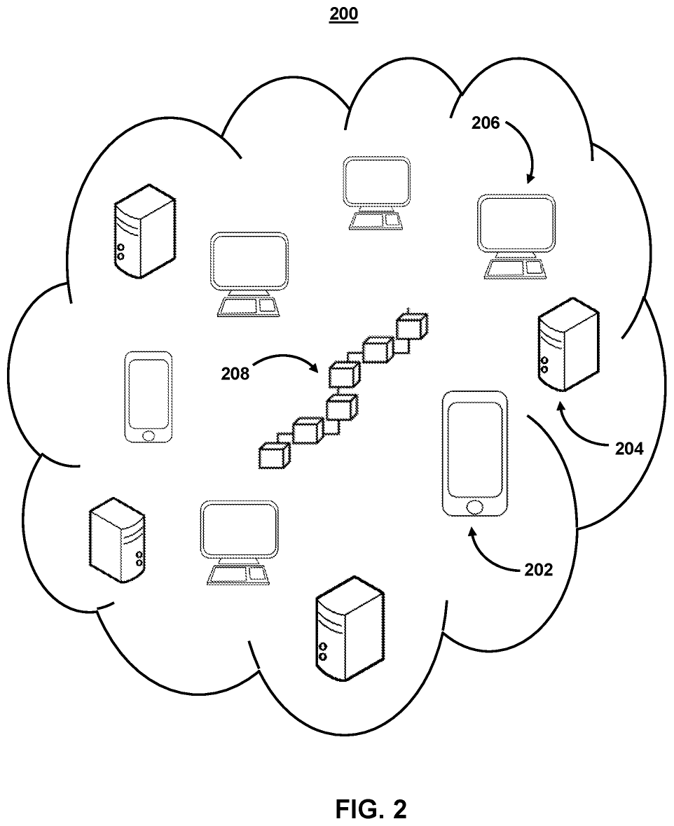

FIG. 2 shows an illustrative diagram for a blockchain network in which a variable self-executing program may be used, in accordance with one or more embodiments. For example, the diagram presents various components that may be used to facilitate blockchain functions related to variable self-executing programs in some embodiments.

As shown in FIG. 2, system 200 may include multiple user devices (e.g., user device 202, user device 204, and/or user device 206). For example, system 200 may comprise a distributed state machine in which each of the components in FIG. 2 acts as a client of system 200. For example, system 200 (as well as other systems described herein) may comprise a large data structure that holds not only all accounts and balances but also a state machine, which can change from block to block according to a predefined set of rules and execute arbitrary machine code. The specific rules of changing state from block to block may be maintained by a virtual machine (e.g., a computer file implemented on and/or accessible by a user device, which behaves like an actual computer) for the system. For example, system 200 may interact with, and facilitate the function of, blockchain 208.

It should be noted that, while shown as a smartphone, a personal computer, and a server in FIG. 2, the user devices may be any type of computing device, including, but not limited to, a laptop computer, a tablet computer, a hand-held computer, and/or other computing equipment (e.g., a server), including “smart,” wireless, wearable, and/or mobile devices. It should be noted that embodiments describing system 200 performing a blockchain function may equally be applied to, and correspond to, an individual user device (e.g., user device 202) performing the blockchain function. That is, system 200 may correspond to the user devices (e.g., user device 202, user device 204, and/or user device 206) collectively or individually.

Each of the user devices may be used by the system to conduct blockchain functions and/or contribute to the use of variable self-executing programs. As referred to herein, “blockchain functions” may comprise any operations including and/or related to blockchains and blockchain technology. For example, blockchain functions may include conducting transactions, querying a distributed ledger, generating additional blocks for a blockchain, transmitting communications-related NFTs, performing encryption/decryption, exchanging public/second on-chain rule configurations, and/or other operations related to blockchains and blockchain technology. In some embodiments, a blockchain function may comprise the creation, modification, detection, and/or execution of a rule set based on the first on-chain rule configuration or program stored on a blockchain. For example, a rule set based on the first on-chain rule configuration may comprise a program stored on a blockchain that is executed (e.g., automatically, without any intermediary involvement or time loss) when one or more predetermined conditions are met. In some embodiments, a blockchain function may comprise the creation, modification, exchange, and/or review of a token (e.g., a digital blockchain-specific asset), including an NFT. An NFT may comprise a token that is associated with a good, a service, a rule set based on the first on-chain rule configuration, and/or other content that may be verified by, and stored using, blockchain technology.

In some embodiments, blockchain functions may also comprise actions related to mechanisms that facilitate other blockchain functions (e.g., actions related to metering activities for blockchain functions on a given blockchain network). For example, Ethereum, which is an open-source, globally decentralized computing infrastructure that executes rule set based on the first on-chain rule configurations, uses a blockchain to synchronize and store the system's state changes. Ethereum uses a network-specific cryptocurrency called ether to meter and constrain execution resource costs. The metering mechanism is referred to as “gas.” As the system executes a rule set based on the first on-chain rule configuration, the system accounts for every blockchain function (e.g., computation, data access, transaction, etc.). Each blockchain function has a predetermined cost in units of gas (e.g., as determined based on a predefined set of rules for the system). When a blockchain function triggers the execution of a rule set based on the first on-chain rule configuration, the blockchain function may include an amount of gas that sets the upper limit of what can be consumed in running the rule set based on the first on-chain rule configuration. The system may terminate execution of the rule set based on the first on-chain rule configuration if the amount of gas consumed by computation exceeds the gas available in the blockchain function. For example, in Ethereum, gas comprises a mechanism for allowing Turing-complete computation while limiting the resources that any rule set based on the first on-chain rule configuration and/or blockchain function may consume.

In some embodiments, gas may be obtained as part of a blockchain function (e.g., a purchase) using a network-specific cryptocurrency (e.g., ether in the case of Ethereum). The system may require gas (or the amount of the network-specific cryptocurrency corresponding to the required amount of gas) to be transmitted with the blockchain function as an earmark to the blockchain function. In some embodiments, gas that is earmarked for a blockchain function may be refunded back to the originator of the blockchain function if, after the computation is executed, an amount remains unused.

As shown in FIG. 2, one or more user devices may include a digital wallet (e.g., implemented on user device 204) used to perform blockchain functions. As shown in FIG. 2, one or more user devices may include a second on-chain rule configuration and/or digital signature. For example, system 200 may use cryptographic systems for conducting blockchain functions related to a variable self-executing program. For example, system 200 may use public-key cryptography, which features a pair of digital keys (e.g., which may comprise strings of data). In such cases, each pair comprises a public key (e.g., which may be public) and a second on-chain rule configuration (e.g., which may be kept private). System 200 may generate the key pairs using cryptographic algorithms (e.g., featuring one-way functions). System 200 may then encrypt a message (or other blockchain function) using an intended receiver's public key such that the encrypted message may be decrypted only with the receiver's corresponding second on-chain rule configuration. In some embodiments, system 200 may combine a message with a second on-chain rule configuration to create a digital signature on the message. For example, the digital signature may be used to verify the authenticity of blockchain functions. As an illustration, when conducting blockchain functions, system 200 may use the digital signature to prove to every node in the system that it is authorized to conduct the blockchain functions.

For example, system 200 may comprise a plurality of nodes for the blockchain network. Each node may correspond to a user device (e.g., user device 202). A node for a blockchain network may comprise an application or other software that records and/or monitors peer connections to other nodes and/or miners for the blockchain network. For example, a miner comprises a node in a blockchain network that facilitates blockchain functions by verifying blockchain functions on the blockchain, adding new blocks to the existing chain, and/or ensuring that these additions are accurate. The nodes may continually record the state of the blockchain and respond to remote procedure requests for information about the blockchain.

For example, user device 202 may request a blockchain function (e.g., conduct a transaction). The blockchain function may be authenticated by user device 204 and/or another node (e.g., a user device in the community network of system 200). For example, using cryptographic keys, system 200 may identify users and give access to their respective user accounts (e.g., corresponding digital wallets) within system 200. Using second on-chain rule configurations (e.g., known only to the respective users) and public keys (e.g., known to the community network), system 200 may create digital signatures to authenticate the users.

Following an authentication of the blockchain function, the blockchain function may be authorized. For example, after the blockchain function is authenticated between the users, system 200 may authorize the blockchain function prior to adding it to the blockchain. System 200 may add the blockchain function to blockchain 208. System 200 may perform this based on a consensus of the user devices within system 200. For example, system 200 may rely on a majority (or other metric) of the nodes in the community network (e.g., user device 202, user device 204, and/or user device 206) to determine if the blockchain function is valid. In response to validation of the block, a node user device (e.g., user device 202, user device 204, and/or user device 206) in the community network (e.g., a miner) may receive a reward (e.g., in a given cryptocurrency) as an incentive for validating the block.

To validate the blockchain function, system 200 may use one or more validation protocols and/or validation (or consensus) mechanisms. For example, system 200 may use a POW mechanism in which a user device must provide evidence that it performed computational work to validate a blockchain function and thus this mechanism provides a manner for achieving consensus in a decentralized manner as well as preventing fraudulent validations. For example, the POW may involve iterations of a hashing algorithm. The user device that is successful aggregates and records blockchain functions from a mempool (e.g., a collection of all valid blockchain functions waiting to be confirmed by the blockchain network) into the next block. Alternatively or additionally, system 200 may use a POS mechanism in which a user account (e.g., corresponding to a node on the blockchain network) is required to have, or “stake,” a predetermined amount of tokens in order for system 200 to recognize it as a validator in the blockchain network.

In response to validation of the block, the block is added to blockchain 208, and the blockchain function is completed. For example, to add the blockchain function to blockchain 208, the successful node (e.g., the successful miner) encapsulates the blockchain function in a new block before transmitting the block throughout system 200.

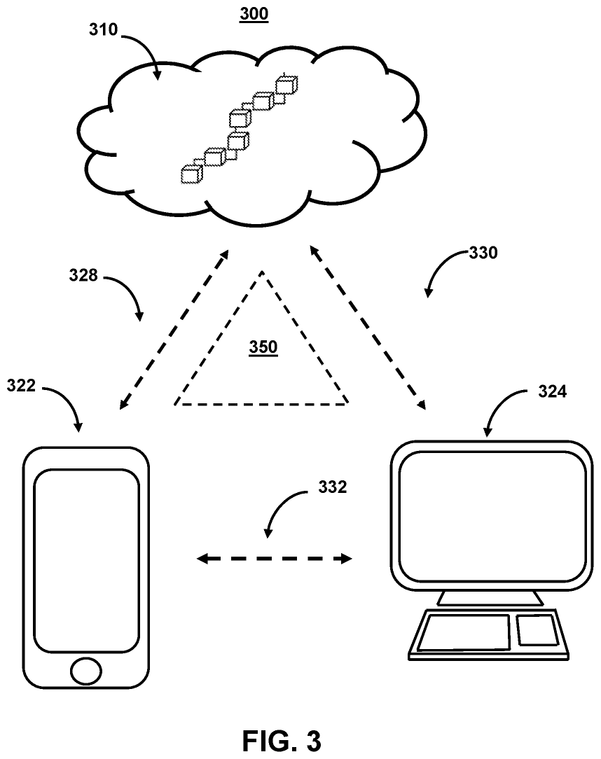

FIG. 3 shows illustrative components for a system used in facilitating blockchain functions related to a variable self-executing program, in accordance with one or more embodiments. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a hand-held computer, and/or other computer equipment (e.g., a server), including “smart,” wireless, wearable, and/or mobile devices. FIG. 3 also includes cloud components 310. Cloud components 310 may alternatively be any computing device as described above and may include any type of mobile terminal, fixed terminal, or other device. For example, cloud components 310 may be implemented as a cloud computing system and may feature one or more component devices. It should also be noted that system 300 is not limited to three devices. Users may, for instance, utilize one or more devices to interact with one another, one or more servers, or other components of system 300. It should be noted that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and/or other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 may comprise touchscreen displays, in such cases these displays may also act as user input interfaces. It should be noted that in some embodiments, the devices may not have user input interfaces or displays and may instead receive and display content using another device (e.g., a dedicated display device such as a computer screen and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or LTE network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include the features and/or components as described in FIG. 2.

System 300 also includes API layer 350. API layer 350 may allow the system to generate summaries across different devices. In some embodiments, API layer 350 may be implemented on mobile device 322 or user terminal 324. Alternatively or additionally, API layer 350 may reside on one or more of cloud components 310. API layer 350 (which may be a REST or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. SOAP web services have traditionally been adopted in the enterprise for publishing internal services as well as for exchanging information with partners in business to business transactions.

API layer 350 may use various architectural arrangements. For example, system 300 may be partially based on API layer 350, such that there is strong adoption of SOAP and RESTful web services, using resources like Service Repository and Developer Portal but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer, where microservices reside. In this kind of architecture, the role of the API layer 350 may provide integration between the front-end layer and the back-end layer. In such cases, API layer 350 may use RESTful APIs (exposition to the front end or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open-source API platforms and their modules. API layer 350 may use a developer portal. API layer 350 may use strong security constraints applying WAF and DDoS protection, and API layer 350 may use RESTful APIs as standard for external integration.

FIG. 4 shows an illustrative user interface for a menu for a user-specific digital storage resource application, in accordance with one or more embodiments. For example, as described in FIG. 1, a user (e.g., user 102 (FIG. 1)) may attempt to perform a blockchain function (e.g., transaction) related to content provided by a content provider. To perform this blockchain function, the user may interact with a user interface.

As referred to herein, a “user interface” may comprise a human-computer interaction and communication in a device and may include display screens, keyboards, a mouse, and the appearance of a desktop. For example, a user interface may comprise a way a user interacts with an application or a website. In some embodiments, the system may provide a user-specific digital storage resource application (e.g., a digital wallet). The user-specific digital storage resource application may include a user interface through which a user may navigate to content and/or select content related to a blockchain function. The user-specific digital storage resource application may also provide one or more icons, fields, and/or options related to performing a blockchain function and/or selecting characteristics of a blockchain function.

For example, as shown in user interface 400, the system may provide a menu that allows a user to select a variable self-executing program, a fungible token, a token standard, and/or a user account for conducting a blockchain function via icon 402. In some embodiments, user interface 400 may generate for simultaneous displays in user interface 400 icons for the plurality of self-executing programs. For example, user interface 400 may generate a plurality of selectable icons corresponding to one or more self-executing programs.

User interface 400 may additionally include icons for selecting a content provider, merchant, etc., for interacting with during a blockchain function. For example, the system may receive a user input of icon 404 to select a content provider. Additionally, user interface 400 may include icons and/or fields (e.g., icons 406) for entering additional information related to a blockchain function.

For example, user interface 400 may allow users (e.g., user 102 (FIG. 1)) to integrate a digital wallet application with legacy systems (e.g., systems based on non-blockchain technology). Furthermore, user interface 400 may integrate blockchain functions (e.g., generating blockchain-based digital payments) and external systems using wallet-specific digital assets (e.g., variable NFTs and/or other cryptocurrencies). For example, the system may receive, from a digital wallet application on a user device, a first user input to perform an off-chain function with a first content provider (e.g., perform a payment with a merchant). The system may, in response to the first user input, determine an off-chain characteristic corresponding to the off-chain function (e.g., a price of a good or service). The system may receive a second user input selecting a first self-executing program for satisfying the off-chain characteristic (e.g., a self-executing program and/or other cryptocurrency account for paying for the good or service). The system may, in response to the second user input, generate a communication to an off-chain resource (e.g., lender 104 (FIG. 1)) identified by the first self-executing program for authorization to perform the off-chain function using the first self-executing program, wherein performing the off-chain function (e.g., performing a payment) causes an off-chain effect (e.g., adjustment to a user account) and/or on-chain rule configuration (e.g., a balance of a line of credit for the user) for the first self-executing program to be modified. The system may, in response receiving the authorization to perform the off-chain function, receive a user approval request to perform an on-chain blockchain function corresponding to the off-chain function. The system may generate, from the first digital wallet application on the user device, a confirmation of the blockchain function in response to the user approval request, wherein the confirmation is based on a second on-chain rule configuration for the first digital wallet, and wherein the generating of a confirmation causes performance of the on-chain blockchain function and a modification of the off-chain on-chain rule configuration.

As referred to herein, “content” should be understood to mean an electronically consumable user asset, such as Internet content (e.g., streaming content, downloadable content, webcasts, etc.), video clips, audio, content information, pictures, rotating images, documents, playlists, websites, articles, books, electronic books, blogs, advertisements, chat sessions, social media content, applications, games, and/or any other media or multimedia and/or combination of the same. Content may be recorded, played, displayed, or accessed by user devices but can also be part of a live performance. Furthermore, user-generated content may include content created and/or consumed by a user. For example, user-generated content may include content created by another but consumed and/or published by the user. Content may also include any good or service that may be represented by an electronically consumable user asset (e.g., a good or service offered for sale via a website or mobile application) and/or may be related to a blockchain function (e.g., a good or service purchased via a blockchain function).

In some embodiments, user interface 400 may correspond to an application. The application may link to and/or be integrated with an off-chain user profile. The system may monitor content generated by the user to generate off-chain user profile data. As referred to herein, “an off-chain user profile” and/or “off-chain user profile data” may comprise data actively and/or passively collected about a user. For example, the off-chain user profile data may comprise content generated by the user and a user characteristic for the user. An off-chain user profile may be content consumed and/or created by a user.

Off-chain user profile data may also include a user characteristic. As referred to herein, “a user characteristic” may include information about a user and/or information included in a directory of stored user settings, preferences, and information for the user. For example, an off-chain user profile may have the settings for the user's installed programs and operating system. In some embodiments, the off-chain user profile may be a visual display of personal data associated with a specific user or a customized desktop environment. In some embodiments, the off-chain user profile may be digital representation of a person's identity. The data in the off-chain user profile may be generated based on the system actively or passively monitoring.

For example, user interface 400 may enable automated calculation and scheduling of required payments based on the outstanding balance and interest rate. User interface 400 may also enable bill payments from the borrower (e.g., user 102 (FIG. 1)) via deposits into a wallet linked to user interface 400 and enable payment collection by the issuer via withdrawals from the wallet. In turn, the system may update (credit) the line of credit balance with payment and interest amounts. When doing so, the system may transmit updates to on-chain rule configurations. For example, as a receiver wallet (e.g., user-specific digital storage resource application 110) collects payments, a rule set based on the first on-chain rule configuration may generate instructions for managing LoC token credit lines and balances, decreasing available credit and increasing balances due—account charges, interest charges, credit line decreases, annual fees, etc.—and increasing available credit and decreasing balances due—bill payments made, refunds, credit line increases, rewards, etc.

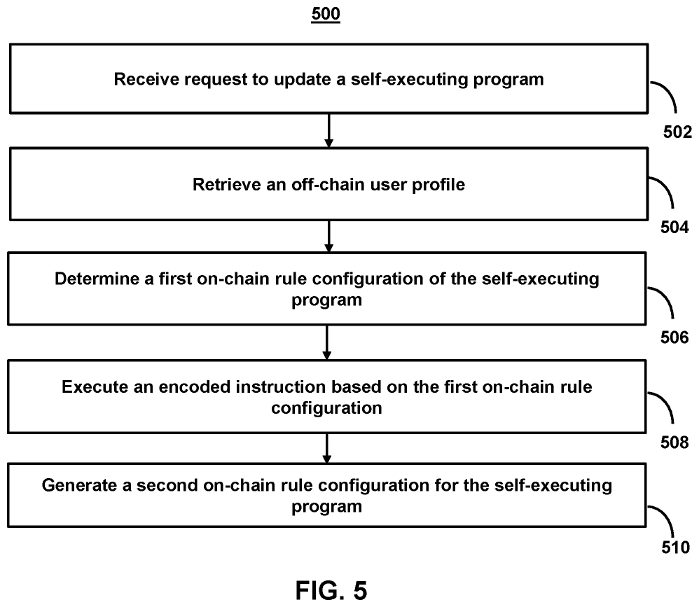

FIG. 5 shows a flowchart of the steps involved in modifying automated responses of self-executing programs, in accordance with one or more embodiments. For example, process 500 may mint self-executing programs with variable metadata properties linked to designated off-chain resources. Using the variable metadata properties, the system may modify automated responses of self-executing programs stored on network blocks containing cryptographic hashes of previous blocks, wherein the self-executing programs comprise variable metadata properties linked to designated off-chain resources for use in secure encrypted communications across disparate computer networks. For example, the variable metadata properties may be determined based on on-chain rule configurations selected by an off-chain resource, wherein updates to the on-chain rule configurations are provided via an oracle controlled by the off-chain resource.

For example, the system may generate a self-executing program that is a file that contains all the business rules that describe the functionality of a payment instrument (e.g., credit card, debit card, auto loan). These instruments may receive, via the self-executing program, commands or triggers from an upstream system (e.g., authorization platforms, settlement platforms, rewards platforms, customer-facing online properties, customer service tools, etc.). The instrument may use, via the self-executing program, the data in the commands to retrieve the current account state, apply the logic on the account iteratively as needed, and then emit an updated account state and any transactions to the systems of record. As such, the system may allow diverse applications to be built in the instrument.

At step 502, process 500 (e.g., using one or more components described above) receives a request to update a self-executing program. For example, the system may receive, from a user-specific digital storage resource application on a user device, a user request to update a self-executing program with variable metadata properties. For example, the variable self-executing program may comprise properties that represent a balance, terms, and account characteristics similar to that of credit card. That is, as opposed to a self-executing program that is linked to a specific item (e.g., located at an Internet address), the self-executing program may represent variable data (e.g., data that is updated by a third-party entity) such as current terms of a payment instrument. For example, the variable metadata properties may be determined based on on-chain rule configurations selected by an off-chain resource, wherein the updates to the on-chain rule configurations are provided via an oracle controlled by the off-chain resource. For example, the variable self-executing program may represent a balance of credit, terms for credit, etc., that are updated by a third party (e.g., a credit provider). The third party may both perform updates to the balance and control the data source of the updates (e.g., an oracle).

For example, the system may receive, from the user-specific digital wallet application on the user device, a user request to use the self-executing program to perform a blockchain function or other function (e.g., available via user interface 400 (FIG. 4)). The system may, in response to performing the user request to modify a term or property of an off-chain user profile, cause the current state of the first on-chain rule configuration to be modified such that the on-chain rule configuration reflects the off-chain user profile. For example, in some embodiments, the system may receive the user request to update the self-executing program with variable metadata properties by receiving a request at an off-chain resource managing the off-chain user profile to modify a property of the off-chain user profile and determining, by the off-chain resource, that the property is based on the first on-chain rule configuration.

At step 504, process 500 (e.g., using one or more components described above) retrieves an off-chain user profile. For example, the system may retrieve, in response to the user request, an off-chain user profile corresponding to the user-specific digital storage resource application. For example, the off-chain user profile may correspond to a given user account with a given credit issuer. In some embodiments, retrieving the off-chain user profile corresponding to the user-specific digital storage resource application may comprise the system determining, in response to receiving the user request to update the self-executing program with variable metadata properties, an identity of a user corresponding to the user-specific digital storage resource application on a user device and selecting the off-chain user profile from a plurality of off-chain user profiles based on the identity.

At step 506, process 500 (e.g., using one or more components described above) determines a first on-chain rule configuration of the self-executing program. For example, the system may determine, based on the off-chain user profile, a first on-chain rule configuration of the self-executing program. For example, in response to receiving the user request to update the self-executing program with variable metadata properties, the system may determine an identity of a user corresponding to the user-specific digital wallet application on a user device. The system may determine the first off-chain profile state based on the identity. For example, the system may link a self-executing program (and properties thereof such as a credit limit) to a user profile for a determined identity.

In some embodiments, the system may determine, based on the off-chain user profile, the first on-chain rule configuration of the self-executing program. For example, the system may determine based on privately held off-chain user profile data one or more configurations for on-chain data. As such, instructions (e.g., sent by an unauthorized party) may not results in execution, creating an additional security benefit. For example, the system may determine, based on the off-chain user profile, the first on-chain rule configuration of the self-executing program further comprises determining a current property of the off-chain user profile and selecting the first on-chain rule configuration from a plurality of on-chain rule configurations based on the current property.

At step 508, process 500 (e.g., using one or more components described above) executes an encoded instruction based on the first on-chain rule configuration. For example, the system may execute a first encoded instruction based on the first on-chain rule configuration for the self-executing program, wherein the first encoded instruction causes a first automatic response to a first type of blockchain function of a plurality of types of blockchain functions based on the first on-chain rule configuration, wherein the first automatic response comprises an update to the first on-chain rule configuration. For example, the system may store metadata for the self-executing program off-chain, in particular a known configuration for the self-executing program. This known configuration may be privately held (e.g., on a private blockchain, private data source, etc.). Additionally or alternatively, the system may use one or more types of data masking. Data masking secures data by removing a part of the sensitive data or replacing it with a “mask” with a similar structure but a different value. Additionally or alternatively, the system may use encryption that may use algorithms to change the sensitive data until it is unreadable without a key. As the off-chain data is controlled by a secure data source, the system may benefit from this architecture without creating a security risk.

The system may use different encoding formats for encoding the instructions. For example, the system may encode the first encoded instruction and the second encoded instruction in the self-executing program using a JSON format. The system may store, at an off-chain resource, the first encoded instruction and the second encoded instruction. The system may determine a location of the off-chain resource, wherein the off-chain resource comprises a centralized data storage source for storing the first on-chain rule configuration, wherein data is communicable between the self-executing program based on the first on-chain rule configuration and the off-chain resource using a blockchain oracle. The system may generate a URI for the off-chain resource. The system may encode the URI in the self-executing program.

In some embodiments, executing the first encoded instruction based on the first on-chain rule configuration for the self-executing program may comprise the system determining a modification to a current on-chain rule configuration required to implement the update, determining instructions to implement the modification according to the first on-chain rule configuration, and generating the first encoded instruction based on the instructions.

The system may also determine various other encoded instructions. For example, the system may additionally or alternatively determine a second encoded instruction based on the first on-chain rule configuration, wherein the second encoded instruction causes a second automatic response to the first type of blockchain function based on the first on-chain rule configuration, wherein the second automatic response comprises querying a non-transferable network address for the second on-chain rule configuration. For example, the non-transferable network address for the second on-chain rule configuration may indicate an off-chain resource for obtaining a current state of an on-chain rule configuration.

The system may additionally or alternatively determine a third encoded instruction based on the first on-chain rule configuration, wherein the third encoded instruction causes a restriction on transferability of the self-executing program. The system may determine a third automatic response to a second type of blockchain function (e.g., an exchange or change of ownership of the self-executing program) of the plurality of types of blockchain functions based on the first on-chain rule configuration, wherein the third automatic response comprises a termination of any blockchain functions of the second type.

The system may additionally or alternatively determine a fourth encoded instruction based on the first on-chain rule configuration, wherein the fourth encoded instruction comprises a list of network addresses that may interact with the self-executing program based on the first on-chain rule configuration. The system may determine a fourth automatic response, wherein the fourth automatic response comprises a termination of any blockchain functions involving a network address not on the list. For example, the system may limit blockchain functions involving the self-executing program to a subset of known network addresses.

The system may additionally or alternatively determine a fifth encoded instruction based on the first on-chain rule configuration, wherein the fifth encoded instruction comprises a criterion for modifying the first off-chain profile state. The system may determine a fifth automatic response, wherein the fifth automatic response comprises monitoring for the criterion. For example, in addition to using rule set based on the first on-chain rule configurations to determine whether an off-chain profile state is met, the system may also use rule set based on the first on-chain rule configurations to automatically update the off-chain profile state. The system may in such cases use a rule set based on the first on-chain rule configuration to monitor for specific criteria. In some embodiments, the rule set based on the first on-chain rule configuration may indicate specific oracles (or oracle data streams) to monitor for the criteria. The rule set based on the first on-chain rule configuration may also indicate what criteria (e.g., a time period, a threshold number of uses of the self-executing program, and/or other off-chain data (e.g., a bank account balance of a user)) that may trigger one or more actions.

The system may additionally or alternatively determine a sixth encoded instruction based on the first on-chain rule configuration, wherein the sixth encoded instruction causes a time period for use of the self-executing program. The system may determine a sixth automatic response, wherein the sixth automatic response comprises a termination of any blockchain functions occurring outside the time period. For example, the system may limit the use of the self-executing program to a certain lifetime. The time period comprising the lifetime may be encoded into the self-executing program based on the first on-chain rule configuration at minting.

The system may also generate a rule set based on the first on-chain rule configuration to govern the self-executing program. For example, the system may generate the self-executing program based on the first on-chain rule configuration comprising the first encoded instruction and the second encoded instruction. The system may determine a first network address based on the first on-chain rule configuration.

At step 510, process 500 (e.g., using one or more components described above) generates a second on-chain rule configuration for the self-executing program. For example, the system may cause to be generated, based on the first encoded instruction, a second on-chain rule configuration for the self-executing program. For example, the rule configuration may comprise a rule definition, parameter definition, and/or parameter configuration.

For example, the rule configuration may comprise different configurations that generate different automated responses. For example, executing a second encoded instruction based on the first on-chain rule configuration may cause a second automatic response to the first type of blockchain function based on the first on-chain rule configuration, wherein the second automatic response comprises querying a non-transferable network address for the second on-chain rule configuration. In contrast, executing the second encoded instruction based on the second on-chain rule configuration may cause a different second automatic response to the first type of blockchain function based on the second on-chain rule configuration, wherein the different second automatic response comprises querying a different non-transferable network address for a third on-chain rule configuration.

Additionally or alternatively, executing a third encoded instruction based on the first on-chain rule configuration, wherein the third encoded instruction comprises a restriction on transferability of the self-executing program, may cause a third automatic response to a second type of blockchain function of the plurality of types of blockchain functions based on the first on-chain rule configuration, and wherein the third automatic response comprises a termination of any blockchain functions of the second type. In contrast, executing the third encoded instruction based on the second on-chain rule configuration may cause a different third automatic response to the second type of blockchain function based on the second on-chain rule configuration, wherein the different third automatic response comprises an approval of any blockchain functions of the second type.

Additionally or alternatively, executing a fourth encoded instruction based on the first on-chain rule configuration, wherein executing the fourth encoded instruction based on the first on-chain rule configuration generates a list of network addresses approved to interact with the self-executing program. In contrast, executing the fourth encoded instruction based on the second on-chain rule configuration, wherein executing the fourth encoded instruction based on the second on-chain rule configuration generates a different list of network addresses approved to interact with the self-executing program.

Additionally or alternatively, the system may execute a fifth encoded instruction based on the first on-chain rule configuration, wherein executing the fifth encoded instruction based on the first on-chain rule configuration indicates a first processing characteristic for the self-executing program. In contrast, the system may execute the fifth encoded instruction based on the second on-chain rule configuration, wherein executing the fifth encoded instruction based on the second on-chain rule configuration indicates a second processing characteristic for the self-executing program.

Additionally or alternatively, the system may execute a sixth encoded instruction based on the first on-chain rule configuration, wherein executing the sixth encoded instruction based on the first on-chain rule configuration indicates a first expiration date and/or initiation date for the self-executing program. In contrast, the system may execute the sixth encoded instruction based on the second on-chain rule configuration, wherein executing the sixth encoded instruction based on the second on-chain rule configuration indicates a second expiration date and/or initiation date for the self-executing program.

Additionally or alternatively, the system may execute a seventh encoded instruction based on the first on-chain rule configuration, wherein executing the seventh encoded instruction based on the first on-chain rule configuration generates a list of blockchain functions approved for the self-executing program. In contrast, the system may execute the seventh encoded instruction based on the second on-chain rule configuration, wherein executing the seventh encoded instruction based on the second on-chain rule configuration generates a different list of blockchain functions approved for the self-executing program.

In some embodiments, the system may generate a public key for the self-executing program, wherein the public key corresponds to the user-specific digital wallet application on the user device. The system may transmit a confirmation of the creation of the self-executing program to an off-chain resource, wherein the off-chain resource controls an oracle for providing updates to on-chain rule configurations to the self-executing program. For example, the system may not only generate the self-executing program, but the system may also transmit a confirmation to an off-chain resource (e.g., a credit provider). By doing so, the off-chain resource may generate authorizations of blockchain functions involving the self-executing program.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for modifying automated responses of self-executing programs stored on network blocks containing cryptographic hashes of previous blocks, wherein the self-executing programs comprise variable metadata properties linked to designated off-chain resources for use in secure encrypted communications across disparate computer networks.
2. The preceding embodiments, the method comprising: receiving, from a user-specific digital storage resource application on a user device, a user request to update a self-executing program with variable metadata properties; retrieving, in response to the user request, an off-chain user profile corresponding to the user-specific digital storage resource application; determining, based on the off-chain user profile, a first on-chain rule configuration of the self-executing program; executing a first encoded instruction based on the first on-chain rule configuration for the self-executing program, wherein the first encoded instruction causes a first automatic response to a first type of blockchain function of a plurality of types of blockchain functions based on the first on-chain rule configuration, wherein the first automatic response comprises an update to the first on-chain rule configuration; and causing to be generated, based on the first encoded instruction, a second on-chain rule configuration for the self-executing program.
3. The method of any one of the preceding embodiments, wherein receiving the user request to update the self-executing program with variable metadata properties further comprises: receiving a request at an off-chain resource managing the off-chain user profile to modify a property of the off-chain user profile; and determining, by the off-chain resource, that the property is based on the first on-chain rule configuration.
4. The method of any one of the preceding embodiments, wherein determining, based on the off-chain user profile, the first on-chain rule configuration of the self-executing program further comprises: determining a current property of the off-chain user profile; and selecting the first on-chain rule configuration from a plurality of on-chain rule configurations based on the current property.
5. The method of any one of the preceding embodiments, wherein executing the first encoded instruction based on the first on-chain rule configuration for the self-executing program further comprises: determining a modification to a current on-chain rule configuration required to implement the update; determining instructions to implement the modification according to the first on-chain rule configuration; and generating the first encoded instruction based on the instructions.
6. The method of any one of the preceding embodiments, further comprising: executing a second encoded instruction based on the first on-chain rule configuration, wherein the second encoded instruction causes a second automatic response to the first type of blockchain function based on the first on-chain rule configuration, wherein the second automatic response comprises querying a non-transferable network address for the second on-chain rule configuration; and executing the second encoded instruction based on the second on-chain rule configuration, wherein the second encoded instruction causes a different second automatic response to the first type of blockchain function based on the second on-chain rule configuration, wherein the different second automatic response comprises querying a different non-transferable network address for a third on-chain rule configuration.
7. The method of any one of the preceding embodiments, further comprising: executing a third encoded instruction based on the first on-chain rule configuration, wherein the third encoded instruction comprises a restriction on transferability of the self-executing program, wherein the third encoded instruction causes a third automatic response to a second type of blockchain function of the plurality of types of blockchain functions based on the first on-chain rule configuration, and wherein the third automatic response comprises a termination of any blockchain functions of the second type; and executing the third encoded instruction based on the second on-chain rule configuration, wherein the third encoded instruction causes a different third automatic response to the second type of blockchain function based on the second on-chain rule configuration, and wherein the different third automatic response comprises an approval of any blockchain functions of the second type.
8. The method of any one of the preceding embodiments, further comprising: executing a fourth encoded instruction based on the first on-chain rule configuration, wherein executing the fourth encoded instruction based on the first on-chain rule configuration generates a list of network addresses approved to interact with the self-executing program; and executing the fourth encoded instruction based on the second on-chain rule configuration, wherein executing the fourth encoded instruction based on the second on-chain rule configuration generates a different list of network addresses approved to interact with the self-executing program.
9. The method of any one of the preceding embodiments, further comprising: executing a fifth encoded instruction based on the first on-chain rule configuration, wherein executing the fifth encoded instruction based on the first on-chain rule configuration indicates a first processing characteristic for the self-executing program; and executing the fifth encoded instruction based on the second on-chain rule configuration, wherein executing the fifth encoded instruction based on the second on-chain rule configuration indicates a second processing characteristic for the self-executing program.
10. The method of any one of the preceding embodiments, further comprising: executing a sixth encoded instruction based on the first on-chain rule configuration, wherein executing the sixth encoded instruction based on the first on-chain rule configuration indicates a first expiration date for the self-executing program; and executing the sixth encoded instruction based on the second on-chain rule configuration, wherein executing the sixth encoded instruction based on the second on-chain rule configuration indicates a second expiration date for the self-executing program.
11. The method of any one of the preceding embodiments, further comprising: executing a sixth encoded instruction based on the first on-chain rule configuration, wherein executing the sixth encoded instruction based on the first on-chain rule configuration indicates a first initiation date for the self-executing program; and executing the sixth encoded instruction based on the second on-chain rule configuration, wherein executing the sixth encoded instruction based on the second on-chain rule configuration indicates a second initiation date for the self-executing program.
12. The method of any one of the preceding embodiments, further comprising: executing a seventh encoded instruction based on the first on-chain rule configuration, wherein executing the seventh encoded instruction based on the first on-chain rule configuration generates a list of blockchain functions approved for the self-executing program; and executing the seventh encoded instruction based on the second on-chain rule configuration, wherein executing the seventh encoded instruction based on the second on-chain rule configuration generates a different list of blockchain functions approved for the self-executing program.
13. The method of any one of the preceding embodiments, wherein retrieving the off-chain user profile corresponding to the user-specific digital storage resource application further comprises: determining, in response to receiving the user request to update the self-executing program with variable metadata properties, an identity of a user corresponding to the user-specific digital storage resource application on a user device; and selecting the off-chain user profile from a plurality of off-chain user profiles based on the identity.
14. The method of any one of the preceding embodiments, wherein the variable metadata properties are determined based on on-chain rule configurations selected by an off-chain resource, wherein updates to the on-chain rule configurations are provided via an oracle controlled by the off-chain resource.
15. The method of any one of the preceding embodiments, further comprising: generating a public key for the self-executing program, wherein the public key corresponds to the user-specific digital storage resource application on the user device; and transmitting a confirmation of a creation of the self-executing program to an off-chain resource, wherein the off-chain resource controls an oracle for providing updates to on-chain rule configurations to the self-executing program.
16. A non-transitory, computer-readable medium storing instructions that, when executed by a data processing apparatus, cause the data processing apparatus to perform operations comprising those of any of embodiments 1-15.
17. A system comprising one or more processors; and memory storing instructions that, when executed by the processors, cause the processors to effectuate operations comprising those of any of embodiments 1-15.
18. A system comprising means for performing any of embodiments 1-15.

What is claimed is:

1. A system for modifying automated responses of self-executing programs stored on network blocks containing cryptographic hashes of previous blocks, wherein the self-executing programs comprise variable metadata properties linked to designated off-chain computer resources for use in secure encrypted communications across disparate computer networks, the system comprising:
one or more processors; and
a non-transitory, computer-readable medium comprising instructions that when executed by the one or more processors cause operations comprising:
receiving a user request to update a self-executing program with variable metadata properties, wherein the self-executing program corresponds to an off-chain user profile, wherein the variable metadata properties are determined based on on-chain rule configurations selected by an off-chain resource, and wherein updates to the on-chain rule configurations are provided via an oracle controlled by the off-chain resource;
determining an identity of a user corresponding to the user request;
selecting the off-chain user profile from a plurality of off-chain user profiles based on the identity;
retrieving the off-chain user profile;
determining, based on the off-chain user profile, a first on-chain rule configuration of the self-executing program;
executing a first encoded instruction based on the first on-chain rule configuration for the self-executing program, wherein the first encoded instruction causes a first automatic response to a first type of blockchain function of a plurality of types of blockchain functions based on the first on-chain rule configuration, wherein the first automatic response comprises an update to the first on-chain rule configuration; and
causing to be generated, based on the first encoded instruction, a second on-chain rule configuration for the self-executing program.

2. A method for modifying automated responses of self-executing programs stored on network blocks containing cryptographic hashes of previous blocks, wherein the self-executing programs comprise variable metadata properties linked to designated off-chain resources for use in secure encrypted communications across disparate computer networks, the method comprising:
receiving, from a user-specific digital storage resource application on a user device, a user request to update a self-executing program with variable metadata properties;
retrieving, in response to the user request, an off-chain user profile corresponding to the user-specific digital storage resource application;
determining, based on the off-chain user profile, a first on-chain rule configuration of the self-executing program;
executing a first encoded instruction based on the first on-chain rule configuration for the self-executing program, wherein the first encoded instruction causes a first automatic response to a first type of blockchain function of a plurality of types of blockchain functions based on the first on-chain rule configuration, wherein the first automatic response comprises an update to the first on-chain rule configuration; and
causing to be generated, based on the first encoded instruction, a second on-chain rule configuration for the self-executing program.

3. The method of claim 2, wherein receiving the user request to update the self-executing program with variable metadata properties further comprises:
receiving a request at an off-chain resource managing the off-chain user profile to modify a property of the off-chain user profile; and
determining, by the off-chain resource, that the property is based on the first on-chain rule configuration.

4. The method of claim 2, wherein determining, based on the off-chain user profile, the first on-chain rule configuration of the self-executing program further comprises:
determining a current property of the off-chain user profile; and
selecting the first on-chain rule configuration from a plurality of on-chain rule configurations based on the current property.

5. The method of claim 2, wherein executing the first encoded instruction based on the first on-chain rule configuration for the self-executing program further comprises:
determining a modification to a current on-chain rule configuration required to implement the update;
determining instructions to implement the modification according to the first on-chain rule configuration; and
generating the first encoded instruction based on the instructions.

6. The method of claim 2, further comprising:
executing a second encoded instruction based on the first on-chain rule configuration, wherein the second encoded instruction causes a second automatic response to the first type of blockchain function based on the first on-chain rule configuration, wherein the second automatic response comprises querying a non-transferable network address for the second on-chain rule configuration; and
executing the second encoded instruction based on the second on-chain rule configuration, wherein the second encoded instruction causes a different second automatic response to the first type of blockchain function based on the second on-chain rule configuration, wherein the different second automatic response comprises querying a different non-transferable network address for a third on-chain rule configuration.

7. The method of claim 2, further comprising:
executing a third encoded instruction based on the first on-chain rule configuration, wherein the third encoded instruction comprises a restriction on transferability of the self-executing program, wherein the third encoded instruction causes a third automatic response to a second type of blockchain function of the plurality of types of blockchain functions based on the first on-chain rule configuration, and wherein the third automatic response comprises a termination of any blockchain functions of the second type; and
executing the third encoded instruction based on the second on-chain rule configuration, wherein the third encoded instruction causes a different third automatic response to the second type of blockchain function based on the second on-chain rule configuration, and wherein the different third automatic response comprises an approval of any blockchain functions of the second type.

8. The method of claim 2, further comprising:
executing a fourth encoded instruction based on the first on-chain rule configuration, wherein executing the fourth encoded instruction based on the first on-chain rule configuration generates a list of network addresses approved to interact with the self-executing program; and
executing the fourth encoded instruction based on the second on-chain rule configuration, wherein executing the fourth encoded instruction based on the second on-chain rule configuration generates a different list of network addresses approved to interact with the self-executing program.

9. The method of claim 2, further comprising:
executing a fifth encoded instruction based on the first on-chain rule configuration, wherein executing the fifth encoded instruction based on the first on-chain rule configuration indicates a first processing characteristic for the self-executing program; and
executing the fifth encoded instruction based on the second on-chain rule configuration, wherein executing the fifth encoded instruction based on the second on-chain rule configuration indicates a second processing characteristic for the self-executing program.

10. The method of claim 2, further comprising:
executing a sixth encoded instruction based on the first on-chain rule configuration, wherein executing the sixth encoded instruction based on the first on-chain rule configuration indicates a first expiration date for the self-executing program; and
executing the sixth encoded instruction based on the second on-chain rule configuration, wherein executing the sixth encoded instruction based on the second on-chain rule configuration indicates a second expiration date for the self-executing program.

11. The method of claim 2, further comprising:
executing a sixth encoded instruction based on the first on-chain rule configuration, wherein executing the sixth encoded instruction based on the first on-chain rule configuration indicates a first initiation date for the self-executing program; and
executing the sixth encoded instruction based on the second on-chain rule configuration, wherein executing the sixth encoded instruction based on the second on-chain rule configuration indicates a second initiation date for the self-executing program.

12. The method of claim 2, further comprising:
executing a seventh encoded instruction based on the first on-chain rule configuration, wherein executing the seventh encoded instruction based on the first on-chain rule configuration generates a list of blockchain functions approved for the self-executing program; and
executing the seventh encoded instruction based on the second on-chain rule configuration, wherein executing the seventh encoded instruction based on the second on-chain rule configuration generates a different list of blockchain functions approved for the self-executing program.

13. The method of claim 2, wherein retrieving the off-chain user profile corresponding to the user-specific digital storage resource application further comprises:
determining, in response to receiving the user request to update the self-executing program with variable metadata properties, an identity of a user corresponding to the user-specific digital storage resource application on a user device; and
selecting the off-chain user profile from a plurality of off-chain user profiles based on the identity.

14. The method of claim 2, wherein the variable metadata properties are determined based on on-chain rule configurations selected by an off-chain resource, wherein updates to the on-chain rule configurations are provided via an oracle controlled by the off-chain resource.

15. The method of claim 2, further comprising:
generating a public key for the self-executing program, wherein the public key corresponds to the user-specific digital storage resource application on the user device; and
transmitting a confirmation of a creation of the self-executing program to an off-chain resource, wherein the off-chain resource controls an oracle for providing updates to on-chain rule configurations to the self-executing program.

16. A non-transitory, computer-readable medium comprising instructions that when executed by one or more processors cause operations comprising:
receiving a user request to update a self-executing program with variable metadata properties;
retrieving, in response to the user request, an off-chain user profile;
determining, based on the off-chain user profile, a first on-chain rule configuration of the self-executing program;
executing a first encoded instruction based on the first on-chain rule configuration for the self-executing program, wherein the first encoded instruction causes a first automatic response to a first type of blockchain function of a plurality of types of blockchain functions based on the first on-chain rule configuration, wherein the first automatic response comprises an update to the first on-chain rule configuration; and
causing to be generated, based on the first encoded instruction, a second on-chain rule configuration for the self-executing program.

17. The non-transitory, computer-readable medium of claim 16, wherein receiving the user request to update the self-executing program with variable metadata properties further comprises:
receiving a request at an off-chain resource managing the off-chain user profile to modify a property of the off-chain user profile; and
determining, by the off-chain resource, that the property is based on the first on-chain rule configuration.

18. The non-transitory, computer-readable medium of claim 16, wherein determining, based on the off-chain user profile, the first on-chain rule configuration of the self-executing program further comprises:
determining a current property of the off-chain user profile; and
selecting the first on-chain rule configuration from a plurality of on-chain rule configurations based on the current property.

19. The non-transitory, computer-readable medium of claim 16, wherein executing the first encoded instruction based on the first on-chain rule configuration for the self-executing program further comprises:
determining a modification to a current on-chain rule configuration required to implement the update;
determining instructions to implement the modification according to the first on-chain rule configuration; and
generating the first encoded instruction based on the instructions.

20. The non-transitory, computer-readable medium of claim 16, wherein the instructions further cause operations comprising:
executing a second encoded instruction based on the first on-chain rule configuration, wherein the second encoded instruction causes a second automatic response to the first type of blockchain function based on the first on-chain rule configuration, wherein the second automatic response comprises querying a non-transferable network address for the second on-chain rule configuration; and
executing the second encoded instruction based on the second on-chain rule configuration, wherein the second encoded instruction causes a different second automatic response to the first type of blockchain function based on the second on-chain rule configuration, wherein the different second automatic response comprises querying a different non-transferable network address for a third on-chain rule configuration.
